(19) United States
(12) Patent Application Publication
(10) Pub. No.: US 2010/0049347 A1
(43) Pub. Date: Feb. 25, 2010

(54) METHOD AND APPARATUS FOR REPRODUCING MULTIMEDIA STREAM REFLECTING USER INTEREST

(76) Inventor: Tae Hun CHO, Guri-si (KR)

Correspondence Address: IPLA P.A., 3550 WILSHIRE BLVD., 17TH FLOOR, LOS ANGELES, CA, 90010, US

(21) Appl. No.: 12/538,443

(22) Filed: Aug. 10, 2009

(30) Foreign Application Priority Data
Aug. 25, 2008 (KR) 10-2008-0082942

(51) Int. Cl. G06F 17/00; G06F 3/048

(52) U.S. Cl. 700/94; 715/716; 715/790

(57) ABSTRACT

A method and apparatus for reproducing multimedia reflecting a user interest are provided. The apparatus includes a network transmitter/receiver, a display unit, an overlap region detector, and a multimedia processor. The network transmitter/receiver receives information on a multi contents page including a multimedia stream. The display unit outputs a predetermined display region within the multi contents page. The overlap region detector detects an overlap region between the display region and a multimedia stream region. The multimedia processor decodes the information on the multi contents page and, if the overlap region is detected, sends a request for data on the multimedia stream to an external server.

### CROSS REFERENCE

This application claims foreign priority under Paris Convention and 35 U.S.C. §119 to each of Korean Patent Application No. 10-2008-0082942, filed 25 Aug. 2008 with the Korean Intellectual Property Office.

### BACKGROUND OF THE INVENTION

1. Field of the Invention

The present invention relates to multimedia stream reproduction. More particularly, the present invention relates to a method and apparatus for reproducing a multimedia stream, for detecting an overlap region between a display region displayed through a user interface in a displayed multi contents page and a multimedia stream region and requesting and reproducing data on a multimedia stream depending on a size of the detected overlap region, thus preventing a network traffic and preventing charging due to unnecessary data packet transmission or performance degradation of a terminal.

2. Description of the Related Art

As a variety of kinds of mobile devices such as a cellular phone, a Portable Digital Assistant (PDA), a Personal Media Player (PMP), etc. have a full-browsing function being able to support wireless Internet and a communication function, multimedia stream reproduction becomes an essential factor. A variety of control schemes for multimedia data having a user convenience for diverse contents are required.

In a conventional multimedia reproduction method, if there is a shift to a multi contents page region, a multimedia stream included in a multi contents page is reproduced according to a reproduction mode. The reproduction mode can be an automatic reproduction mode and a manual reproduction mode. In the automatic reproduction mode, multimedia is reproduced irrespective of a user's intention. In the manual reproduction mode, a multimedia stream is reproduced receiving an input from a user. Among the two reproduction modes, the automatic reproduction mode has a problem that a multimedia stream is reproduced irrespective of a user's intention. In FIG. 1a to 1b, there is a problem when a multimedia stream is reproduced in the automatic reproduction mode according to the conventional technology.

FIG. 1a illustrates a state in which a multimedia stream 102 within a multi contents page 100 is not displayed in a display region 101 of a user interface. FIG. 1b illustrates a state in which a multimedia stream 102 within a multi contents page 100 is displayed in a display region 101 of a user interface. That is, FIG. 1a illustrates a state that the multimedia stream region 102 is not displayed in the display region 101 through the user interface but can be provisionally chosen as the display region 101.

In the case of reproducing the multimedia stream within the multimedia stream region 102 in the automatic reproduction mode, in FIG. 1a, although the multimedia stream within the multimedia stream region 102 is not displayed in the display region 101, because the multimedia stream is reproduced, a network traffic may be generated due to a data request, etc. and also, a charge may be generated due to unnecessary data packet transmission, etc., resulting in performance degradation of a terminal. Also, due to this unnecessary reproduction, a terminal user feels an inconvenience.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide an apparatus and method for reproducing multimedia, for preventing network traffic generation, charging due to unnecessary data packet transmission, or performance degradation of a terminal.

To achieve these and other advantages and in accordance with the purpose of the present invention, an apparatus for reproducing multimedia reflecting a user interest is provided. The apparatus includes a network transmitter/receiver, a display unit, an overlap region detector, and a multimedia processor. The network transmitter/receiver receives information on a multi contents page including a multimedia stream. The display unit outputs a predetermined display region within the multi contents page, on the basis of decoded information on the multi contents page. The overlap region detector detects an overlap region between the display region output through the display unit and a multimedia stream region within the multi contents page. The multimedia processor decodes the information on the multi contents page received through the network transmitter/receiver and, if the overlap region is detected, sends a request for data on the multimedia stream to an external server.

The overlap region detector may detect the overlap region on the basis of coordinates of the display region and the multimedia stream region.

If the overlap region has a predetermined size or more, the multimedia processor may send the request for the data on the multimedia stream.

If the overlap region has a predetermined size or more, the multimedia processor may reproduce the multimedia stream.

When reproducing the multimedia stream, the multimedia processor may reproduce an audio among the multimedia stream by fade-in.

If the overlap region is no longer detected, the multimedia processor may stop the reproduction.

According to one aspect of the present invention, a method for reproducing multimedia reflecting a user interest is provided. The method includes (a) receiving information on a multi contents page including a multimedia stream, (b) decoding the received information on the multi contents page and, on the basis of the decoded information on the multi contents page, outputting a predetermined display region within the multi contents page, (c) detecting an overlap region between the outputted display region and a multimedia stream region within the multi contents page, and (d) if the overlap region is detected, sending a request for data on the multimedia stream to an external server.

In the (c), the overlap region may be detected on the basis of coordinates of the display region and the multimedia stream region.

The (d) may send a request for data on the multimedia stream if the overlap region has a predetermined size or more.

The (d) may further include reproducing the multimedia stream if the overlap region has a predetermined size or more.

The method may further include reproducing an audio among the multimedia stream by fade-in when reproducing the multimedia stream.

The method may further include stopping the reproduction if the overlap region is no longer detected.

According to another aspect of the present invention, a recording medium is provided. The recording medium is readable by a computer having a record of a program for executing the method.

The present invention can prevent network traffic generation, charging due to unnecessary data packet transmission, or performance degradation of a terminal, by detecting whether if a multimedia stream to be reproduced in a multimedia page is positioned in a user interested region, that is, a display region and reproducing the multimedia stream only if the multimedia stream is positioned in the user interested region.

### BRIEF DESCRIPTION OF THE DRAWINGS

The above and other objects, features and advantages of the present invention will become more apparent from the following detailed description when taken in conjunction with the accompanying drawings in which:

FIG. 1a to 1b is a diagram illustrating a problem when a multimedia stream is reproduced in an automatic reproduction mode according to the conventional art;

FIG. 2 is a block diagram illustrating a construction of an apparatus for reproducing multimedia reflecting a user interest according to an exemplary embodiment of the present invention;

FIG. 3a to 3e are diagrams illustrating data request and audio/video reproduction or not depending on a size of an overlap region between a display region and a multimedia stream region according to an exemplary embodiment of the present invention;

FIG. 4 is a diagram for describing overlap region detection according to an exemplary embodiment of the present invention;

FIGS. 5a to 5c are diagrams illustrating a size of each of a multimedia stream region and a display region; and

FIG. 6 is a flow diagram illustrating a method for reproducing multimedia reflecting a user interest according to an exemplary embodiment of the present invention.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

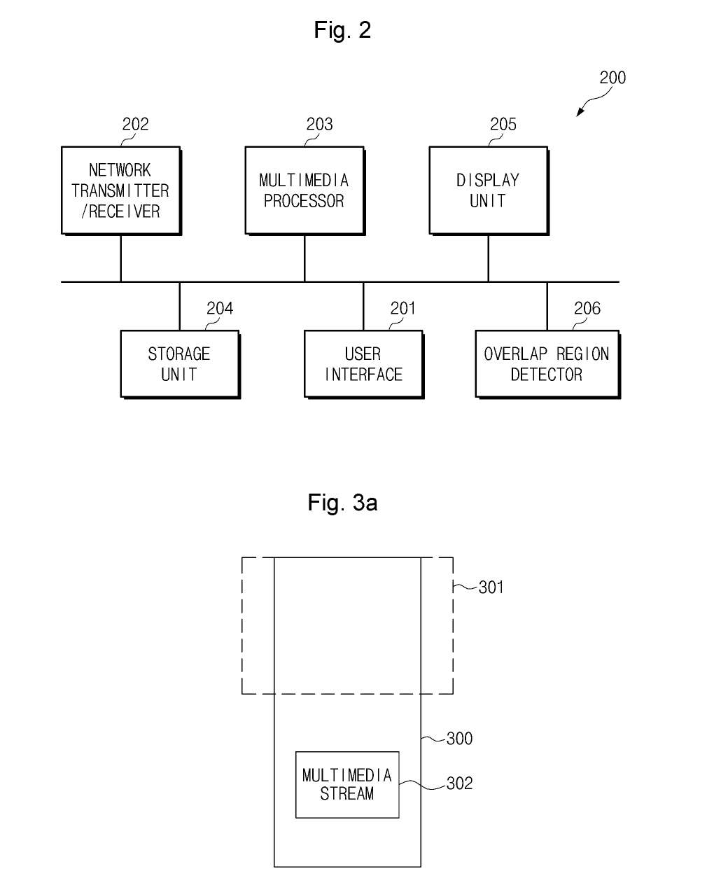

FIG. 2 is a block diagram illustrating a construction of an apparatus 200 for reproducing multimedia reflecting a user interest according to an exemplary embodiment of the present invention. The apparatus 200 includes a user interface 201, a network transmitter/receiver 202, a multimedia processor 203, a storage unit 204, a display unit 205, and an overlap region detector 206.

In FIG. 2, the user interface 201 is a device for interfacing with the apparatus 200. The user interface 201 receives an input of an existing reproduction mode or a reproduction mode according to the present invention from a user, and delivers the received input to the multimedia processor 203. If receiving a multi contents page request from the user, the user interface 201 delivers the multi contents page request to the multimedia processor 203 or, if a display region 301 within a multi contents page is changed by the user, delivers this information to the multimedia processor 203.

Under control of the multimedia processor 203, the network transmitter/receiver 202 sends a request for a multi contents page including a multimedia stream to an external server (not shown) using a protocol such as HyperText Transport Protocol (HTTP) or Multicast & Multidestination Transport Protocol (MMTP). Also, if receiving information on a multi contents page from the external server (not shown) under control of the multimedia processor 203, the network transmitter/receiver 202 stores the information in the storage unit 204. Here, the information on the multi contents page can be a general Web page in an exemplary embodiment of the present invention. Also, under control of the multimedia processor 203, the network transmitter/receiver 202 receives and stores data on a multimedia stream in the storage unit 204.

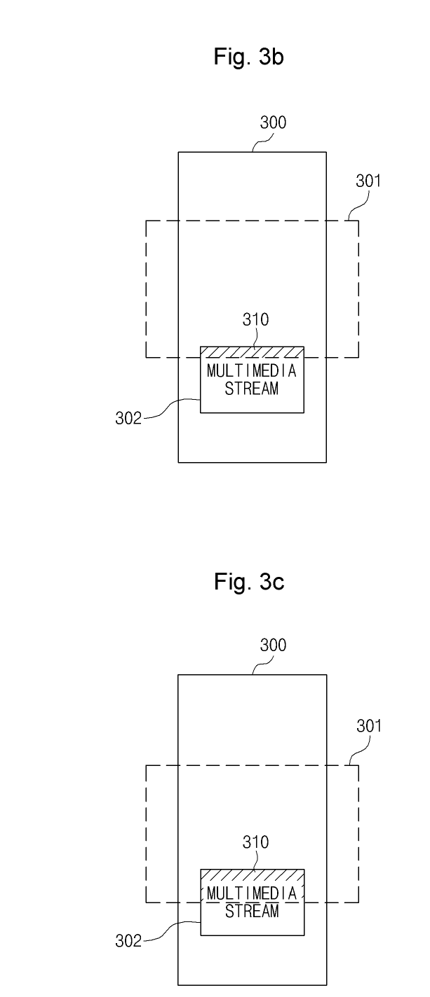

The multimedia processor 203 decodes the multi contents page information stored in the storage unit 204 and again stores the decoded information in the storage unit 204. If the overlap region detector 206 detects an overlap region, the multimedia processor 203 sends a request for data on a multimedia stream to the external server (not shown). Here, the overlap region refers to a region overlapped between a display region (301 of FIGS. 3a to 3e) and a multimedia stream region (302 of FIGS. 3a to 3e) including a multimedia stream. Determining data request and audio/video reproduction or not depending on a size of the overlap region according to an exemplary embodiment of the present invention is described below in detail with reference to FIGS. 3a to 3e.

FIGS. 3a to 3e are diagrams illustrating data request and audio/video reproduction or not depending on a size of an overlap region between a display region and a multimedia stream region according to an exemplary embodiment of the present invention. A reference numeral ‘300’ denotes a multi contents page region, a reference numeral ‘301’ denotes a display region output by a display unit 205, and a reference numeral ‘302’ denotes a multimedia stream region including a multimedia stream. Table 1 shows an example of data request and audio/video reproduction or not depending on a size of an overlap region in association with FIGS. 3a to 3e.

FIG. 3a illustrates that the overlap region between the display region 301 and the multimedia stream region 302 among the multi contents page 300 is equal to 0%. In FIG. 3a, among the multimedia stream, an audio or video is in a still state with no reproduction, and there is no request for data on the multimedia stream to an external server (not shown) through a network control.

FIG. 3b illustrates that the overlap region between the display region 301 and the multimedia stream region 302 among the multi contents page 300 is equal to 10%. In FIG. 3b, among the multimedia stream, an audio or video is in a still state with no reproduction, but there is a request for data on the multimedia stream for multimedia stream reproduction to the external server (not shown) through the network control.

FIG. 3c illustrates that the overlap region between the display region 301 and the multimedia stream region 302 among the multi contents page 300 is equal to 50%. In FIG. 3c, among the multimedia stream, an audio or video is continuously reproduced, and there is a continuous request for data on the multimedia stream for multimedia stream reproduction to the external server (not shown) through the network control. In an exemplary embodiment of the present invention, an audio volume is set to ‘Fade-in’ or is previously set to a range of about 50% to 100% of the original volume, thus being capable of eliminating a burden due to sudden multimedia stream reproduction.

FIG. 3d illustrates that that the overlap region between the display region 301 and the multimedia stream region 302 among the multi contents page 300 is equal to 100%. In FIG. 3d, among the multimedia stream, an audio or video is continuously reproduced, and there is a continuous request for data on the multimedia stream for multimedia stream reproduction to the external server (not shown) through the network control. An audio volume follows the original volume.

FIG. 3e illustrates that the overlap region between the display region 301 and the multimedia stream region 302 among the multi contents page 300 is equal to 0%. FIG. 3e represents that a user interest is far away from the multimedia stream region 302 and thus, a multimedia stream under reproduction, i.e., an audio or video is stopped without reproduction. A network control for a multimedia data request is stopped so as to reduce a network traffic due to a request for data on a multimedia stream and charging due to a data packet request, etc. According to an exemplary embodiment of the present invention, an audio volume can be set to ‘Fade-out’ unlike FIG. 3c.

TABLE 1

| | Overlap | | | Network |
|---|---|---|---|---|
| Conditions | region | Audio control | Video control | control |
| FIG. 3a | 0% | Stop | Stop | No request |
| FIG. 3b | 10% | Stop | Stop | Request |
| FIG. 3c | 50% | Fade in | Reproduce | Request |
| FIG. 3d | 100% | 100% in volume | Reproduce | Request |
| FIG. 3e | 0% | Fade out | Stop | No request |

In FIGS. 3a to 3e, a description is made using a concrete numerical value as an example, but this is only for a convenience of understanding and does not necessarily intend to limit the scope of the present invention. The overlap region can be realized by various numerical values of 5%, 12%, etc. Inversely, even when going to FIG. 3a starting from FIG. 3e, it goes on in the aforementioned manner. However, according to an exemplary embodiment of the present invention, construction can be such that, if a multimedia stream is stopped during reproduction, reproduction is performed starting from a time when a user is provided lastly.

The storage unit 204 stores information on a multi contents page including a multimedia stream received from the external server (not shown) through the network transmitter/receiver 202, and stores the information on the multi contents page decoded by the multimedia processor 203. The storage unit 204 stores data on the multimedia stream received from the external server (not shown). In the present invention, it is presupposed that all information or data are once stored in the storage unit 204, but it is obvious to those skilled in the art that real-time implementation can be made without a separate storage unit 204 according to an exemplary embodiment of the present invention.

The display unit 205 is a device such as a Liquid Crystal Display (LCD). The display unit 205 displays a predetermined display region (301 of FIGS. 3a to 3e) within a multi contents page on the basis of decoded information on a multi contents page.

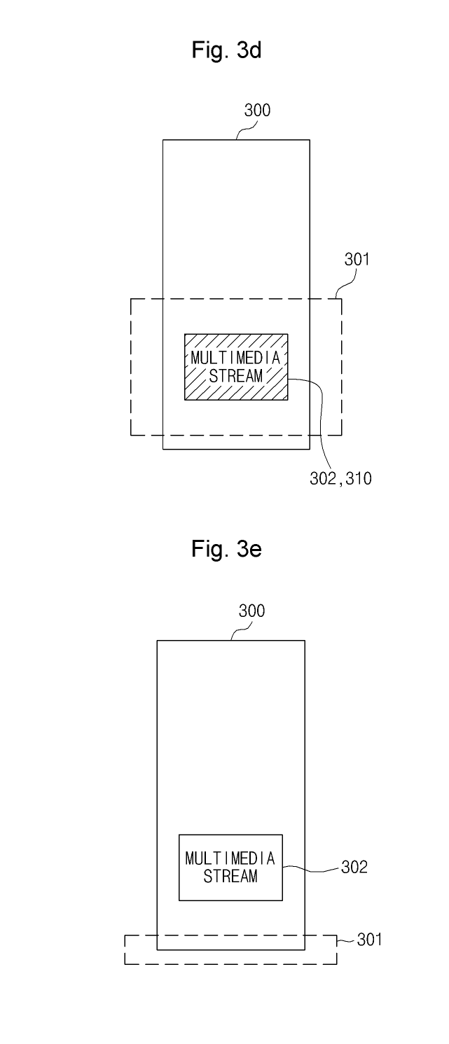

The overlap region detector 206 detects an overlap region between a display region (301 of FIGS. 3a to 3e) output through the display unit 205 and a multimedia stream region 302 within a multi contents page 300, and delivers the overlap region to the multimedia processor 203. Detecting an overlap region according to an exemplary embodiment of the present invention is described below in detail with reference to FIG. 4.

FIG. 4 is a diagram for describing overlap region detection according to an exemplary embodiment of the present invention. First, an overlap region is detectable on the basis of coordinates of a display region 301 and a multimedia stream region 302. Referring to FIG. 4, the display region 301 has four coordinates (A1, B1), (A2, B1), (A1, B2), and (A2, B2), and the multimedia stream region 302 has four coordinates of (X1, Y1), (X2, Y1), (X1, Y2), and (X2, Y2). Accordingly, if there is any one coordinate X1 or X2 of the multimedia stream region 302 between the A1 and A2, it can be determined that there is the overlap region. Also, if there is any one coordinate Y1 or Y2 of the multimedia stream region 302 between the B1 and B2, it can be determined that there is the overlap region.

In FIG. 4, a size of the overlap region 301 can be calculated as in (X2−X1)×(Y1−B2), and a size of the multimedia stream region 302 is equal to (X2−X1)×(Y1−Y2) and thus, the overlap region 301 can be expressed in percentage. It is obvious to those skilled in the art that the above overlap region detection and size calculation are merely one exemplary implementation, and calculation can be performed in a different manner depending on a system construction.

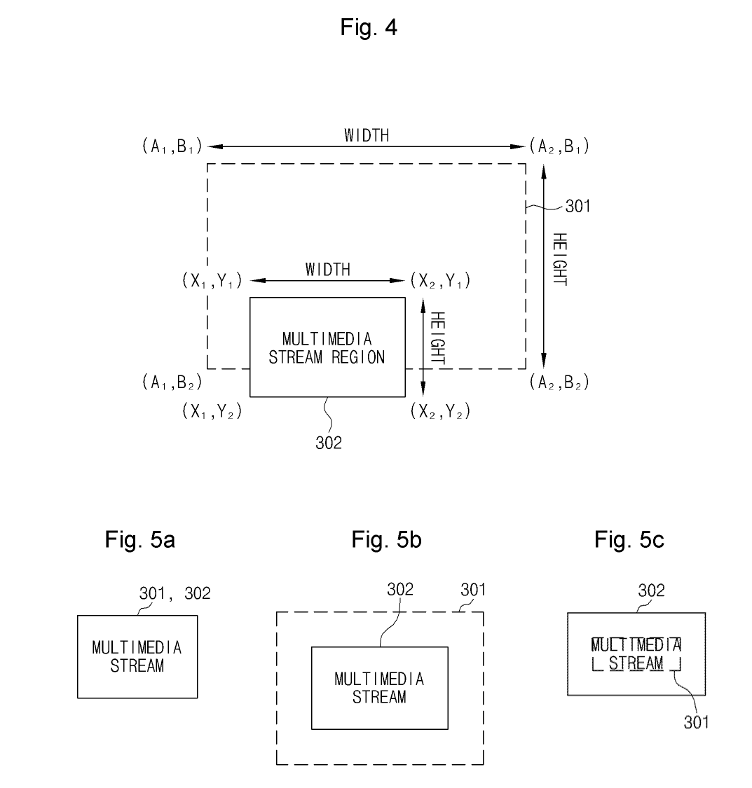

FIGS. 5a to 5c illustrate a size of each of a multimedia stream region and a display region according to an exemplary embodiment of the present invention. FIG. 5a illustrates that the display region 301 and the multimedia stream region 302 have the same size. FIG. 5b illustrates that the display region 301 is greater in size than the multimedia stream region 302. FIG. 5c illustrates that the display region 301 is less in size than the multimedia stream region 302. As such, the sizes of the display region 301 and the multimedia stream region 302 can be modified and realized in various manners.

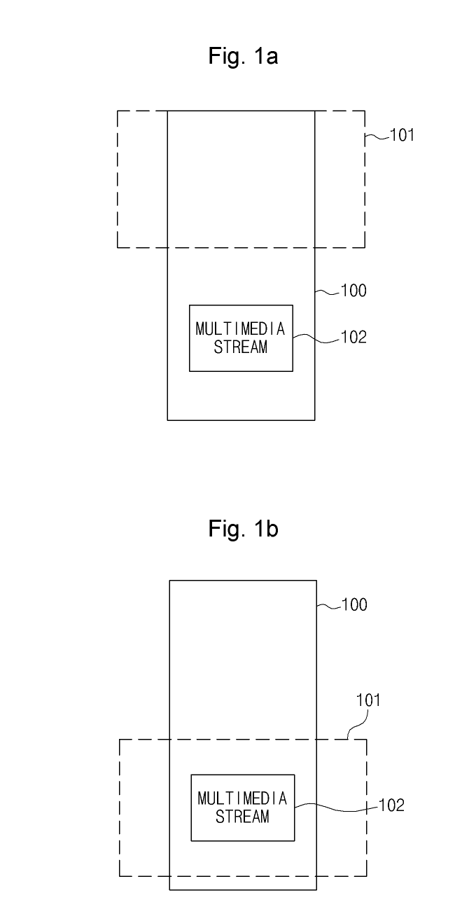

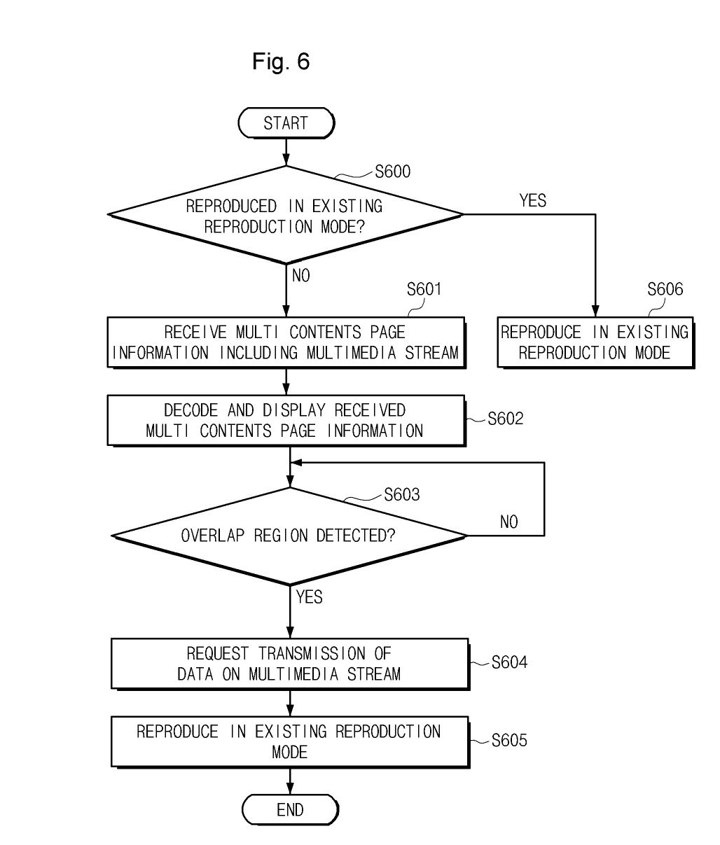

FIG. 6 is a flow diagram illustrating a method for reproducing multimedia reflecting a user interest according to an exemplary embodiment of the present invention. For description convenience of the present invention, FIGS. 1 to 5 and a duplicate description are omitted.

First, in step 600, a multimedia processor 203 determines whether to reproduce a multimedia stream in an existing reproduction mode, on the basis of a key value inputted from a user through a user interface 201. If it is determined to reproduce the multimedia stream in the existing reproduction mode, the multimedia processor 203 goes to step 606 and reproduces the multimedia stream in the existing reproduction mode. Otherwise, the multimedia processor 203 goes to step 601.

In step 601, the multimedia processor 203 sends a request for a multi contents page to an external server (not shown) through a network transmitter/receiver 202, and stores multi contents page information including a multimedia stream received from the external server (not shown) in the storage unit 204.

In step 602, the multimedia processor 203 reads the multi contents page information including the multimedia stream stored in the storage unit 204, and decodes and stores the multi contents page information in the storage unit 204.

In step 603, the overlap region detector 206 detects an overlap region between a display region and a multimedia stream region as described above, calculates a size of the overlap region, and delivers the calculated size to the multimedia processor 203.

In step 604, the multimedia processor 203 sends a request for data on a multimedia stream to the external server (not shown) depending on the size of the overlap region in a manner of Table 1.

After that, in step 604, the multimedia processor 203 reproduces received multimedia stream data depending on the size of the overlap region in the manner of Table 1.

The present invention can be realized using a computer-readable code in a computer-readable recording medium. The computer-readable recording medium includes all kinds of recording devices storing data readable by a computer system. For example, the computer-readable recording medium is a Read Only Memory (ROM), a Random Access Memory (RAM), a Compact Disk (CD)-ROM, a magnetic tape, a floppy disk, an optic data storage device, etc. Also, the computer-readable recording medium is distributed in a computer system connected through a network, and a computer readable code can be stored and executed in a distribution manner.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for reproducing multimedia reflecting a user interest, the apparatus comprising:
a network transmitter/receiver for receiving information on a multi contents page including a multimedia stream;
a display unit for outputting a predetermined display region within the multi contents page, on the basis of decoded information on the multi contents page;
an overlap region detector for detecting an overlap region between the display region output through the display unit and a multimedia stream region within the multi contents page; and
a multimedia processor for decoding the information on the multi contents page received through the network transmitter/receiver and, if the overlap region is detected, sending a request for data on the multimedia stream to an external server.

2. The apparatus of claim 1, wherein the overlap region detector detects the overlap region on the basis of coordinates of the display region and the multimedia stream region.

3. The apparatus of claim 1, wherein, if the overlap region has a predetermined size or more, the multimedia processor sends the request for the data on the multimedia stream.

4. The apparatus of claim 3, wherein, if the overlap region has a predetermined size or more, the multimedia processor reproduces the multimedia stream.

5. The apparatus of claim 4, wherein, when reproducing the multimedia stream, the multimedia processor reproduces an audio among the multimedia stream by fade-in.

6. The apparatus of claim 4, wherein, if the overlap region is no longer detected, the multimedia processor stops the reproduction.

7. A method for reproducing multimedia reflecting a user interest, the method comprising:
(a) receiving information on a multi contents page including a multimedia stream;
(b) decoding the received information on the multi contents page and, on the basis of the decoded information on the multi contents page, outputting a predetermined display region within the multi contents page;
(c) detecting an overlap region between the outputted display region and a multimedia stream region within the multi contents page; and
(d) if the overlap region is detected, sending a request for data on the multimedia stream to an external server.

8. The method of claim 7, wherein, in the (c), the overlap region is detected on the basis of coordinates of the display region and the multimedia stream region.

9. The method of claim 7, wherein the (d) sends a request for data on the multimedia stream if the overlap region has a predetermined size or more.

10. The method of claim 9, wherein the (d) further comprises reproducing the multimedia stream if the overlap region has a predetermined size or more.

11. The method of claim 10, further comprising reproducing an audio among the multimedia stream by fade-in when reproducing the multimedia stream.

12. The method of claim 10, further comprising stopping the reproduction if the overlap region is no longer detected.

13. A recording medium readable by a computer having a record of a program for executing a method, the method comprising:
(a) receiving information on a multi contents page including a multimedia stream;
(b) decoding the received information on the multi contents page and, on the basis of the decoded information on the multi contents page, outputting a predetermined display region within the multi contents page;
(c) detecting an overlap region between the outputted display region and a multimedia stream region within the multi contents page; and
(d) if the overlap region is detected, sending a request for data on the multimedia stream to an external server.
